(19) United States
(12) Patent Application Publication
(10) Pub. No.: US 2021/0209600 A1
(43) Pub. Date: Jul. 8, 2021

(54) SYSTEMS AND METHODS FOR PROVIDING A REPUTATION SCORE FOR AN ENTITY

(71) Applicant: Wells Fargo Bank, N.A., San Francisco, CA (US)

(72) Inventors: Laura M. Fontana, San Francisco, CA (US); Kristine Ing Kushner, Orinda, CA (US); Muhammad Farukh Munir, Pittsburg, CA (US); Brian M. Pearce, Pleasanton, CA (US); Paul Vittimberga, Oakland, CA (US)

(21) Appl. No.: 15/392,859

(22) Filed: Dec. 28, 2016

(51) Int. Cl. G06Q 20/40; G06F 7/02

(52) U.S. Cl. CPC G06Q 20/4016; G06F 7/02

(57) ABSTRACT

Systems and methods of generating a reputation score for an entity are provided. A plurality of financial transactions associated with the entity can be processed. Each of the plurality of financial transactions can be associated with a respective one of a plurality of transaction types, based on a result associated with each of the plurality of financial transactions. External reputation information relating to the entity can be received. The reputation score for the entity can be generated based on the transaction types of the plurality of financial transactions and the external reputation information.

### TECHNICAL FIELD

Embodiments of the present disclosure generally relate to the field of ratings for businesses and individuals.

### BACKGROUND

Embodiments of the present disclosure generally relate to the field of ratings for businesses and individuals. Businesses and individuals may inquire about the reputation of an entity (e.g., a merchant or another individual) before conducting business with the entity. Such reputation information may help to asses a level of risk associated with conducting business with the entity. However, reputation information for an entity can be difficult to obtain, and also may be unreliable. For example, reputation information may be generated based on biased sources, or may be otherwise manipulated so that the reputation information does not facilitate an accurate risk assessment of the entity.

### SUMMARY

To provide reputation information having a high degree of accuracy and reliability, a reputation score can be generated based in part on verified financial information. The financial information can relate to financial transactions between the entity whose reputation is being assessed and a plurality of other entities, who may be individuals, merchants, or other organizations. Such information may be more reliable than other types of self-reported reputation information, such as unmoderated and/or unverified reviews which may be influenced in a variety of ways by the entity itself to improve its perceived reputation. For example, an entity may submit positive reviews of itself, or may pay others to provide positive reviews of itself, in an attempt to inflate its perceived reputation among potential customers, clients, or other transaction counterparties. Verified financial information may be more objective and, therefore, may be analyzed to provide a more objective reputation score for the entity. In some arrangements, the verified financial information may be aggregated with other external reputation information to provide a more comprehensive reputation score for the entity. The reputation score also may include a confidence metric component, which can indicate a level of confidence that the reputation score accurately reflects the reputation of the entity among potential customers, clients, and other transaction counterparties. Thus, businesses and individuals may use such a reputation score of an entity to accurately and confidently assess a risk level of conducting business with the entity.

One example embodiment relates to a computer-implemented method for providing a reputation score for an entity. The method includes processing, by an account management circuit, a plurality of financial transactions associated with the entity. The method further includes associating, by a transaction categorization circuit, each of the plurality of financial transactions with a respective one of a plurality of transaction types, based on a result associated with each of the plurality of financial transactions. The method includes receiving, by a reputation scoring circuit, external reputation information relating to the entity. The method includes generating, by the reputation scoring circuit, the reputation score for the entity, based on the transaction types of the plurality of financial transactions and the external reputation information.

In some arrangements, the plurality of transaction types can include at least one of a sale, a return, a disputed credit card transaction, and a declined credit card transaction. In some arrangements, generating the reputation score for the entity includes generating, by the reputation scoring circuit, the reputation score for the entity based on a relative percentage of each transaction type for the plurality of financial transactions.

In some arrangements, the method includes determining, by the reputation scoring circuit, a total number of financial transactions included within the plurality of financial transactions. Generating the reputation score for the entity also can include generating, by the reputation scoring circuit, the reputation score for the entity based on the total number of financial transactions.

In some arrangements, the method includes determining, by a confidence determination circuit, a confidence metric associated with the reputation score of the entity, based on the total number of financial transactions included within the plurality of financial transactions. In some arrangements, the method includes determining, by a risk determination circuit, a credit risk associated with the entity, based at least in part on the reputation score of the entity. In some arrangements, the external reputation information includes information corresponding to at least one of social media activity relating to the entity, a criminal record associated with the entity, tax information for the entity, and customer feedback associated with the entity.

In some arrangements, the method includes determining, by the reputation scoring circuit, an identity of a counterparty for each of the plurality of financial transactions. The method also can include determining, by the reputation scoring circuit, a number of repeat customers based on the identity of the counterparty determined for each of the plurality of financial transactions. The method also can include generating, by the reputation scoring circuit, the reputation score for the entity based at least in part on the number of repeat customers. In some arrangements, the entity can be a business. In some arrangements, the entity is an individual.

In some arrangements, the method includes storing, by the reputation scoring circuit, the reputation score of the entity in a data storage device. The method also can include receiving, by a score providing circuit, a request for the reputation score for the entity. The method also can include transmitting, by the score providing circuit, information corresponding to the reputation score for the entity to cause the reputation score for the entity to be displayed on an electronic display screen.

Another example embodiment relates to a system for providing a reputation score for an entity. The system includes an account management circuit configured to process a plurality of financial transactions associated with the entity. The system includes a transaction categorization circuit configured to associate each of the plurality of financial transactions with a respective one of a plurality of transaction types, based on a result associated with each of the plurality of financial transactions. The system includes a reputation scoring circuit configured to receive external reputation information relating to the entity and to generate the reputation score for the entity, based on the transaction types of the plurality of financial transactions and the external reputation information.

In some arrangements, the plurality of transaction types includes at least one of a sale, a return, a disputed credit card transaction, and a declined credit card transaction. In some arrangements, the reputation scoring circuit is further configured to generate the reputation score for the entity based on a relative percentage of each transaction type for the plurality of financial transactions.

In some arrangements, the reputation scoring circuit is further configured to determine a total number of financial transactions included within the plurality of financial transactions, and to generate the reputation score for the entity based on the total number of financial transactions.

In some arrangements, the system includes a confidence determination circuit configured to determine a confidence metric associated with the reputation score of the entity, based on the total number of financial transactions included within the plurality of financial transactions. In some arrangements, the system includes a risk determination circuit configured to determine a credit risk associated with the entity, based at least in part on the reputation score of the entity. In some arrangements, the external reputation information includes information corresponding to at least one of social media activity relating to the entity, a criminal record associated with the entity, tax information for the entity, and customer feedback associated with the entity.

In some arrangements, the reputation scoring circuit is further configured to determine an identity of a counterparty for each of the plurality of financial transactions. The reputation scoring circuit also can be configured to determine a number of repeat customers based on the identity of the counterparty determined for each of the plurality of financial transactions. The reputation scoring circuit also can be configured to generate the reputation score for the entity based at least in part on the number of repeat customers. In some arrangements, the entity can be a business. In some arrangements, the entity is an individual.

In some arrangements, the reputation scoring circuit is further configured to store the reputation score of the entity in a data storage device. The system can further include a score providing circuit configured to receive a request for the reputation score for the entity, and to transmit information corresponding to the reputation score for the entity to cause the reputation score for the entity to be displayed on an electronic display screen.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of a computing environment for providing a reputation score for an entity, according to an illustrative implementation;

FIG. 2 is a detailed schematic diagram of the computing environment of FIG. 1, according to an illustrative implementation;

FIG. 3 is detailed schematic diagram of a reputation scoring system included in the environment of FIG. 2;

FIG. 4 is a flowchart illustrating an example method for providing a reputation score for an entity, according to an illustrative implementation; and

### DETAILED DESCRIPTION

The present disclosure is generally directed to systems and methods for providing a reputation score for an entity. Before conducting business with an entity, such as a merchant or an individual, it may be beneficial to assess any potential risk that may be associated with conducting the business. For example, the reputation of the entity may inform an individual or another merchant about difficulties that have been encountered by others who have conducted business with the entity in the past. Thus, individuals and businesses often seek reputation information for an entity before entering into a financial transaction with the entity.

In some instances, reputation information may be provided by a review aggregator, for example via a publicly accessible website. Typically, review aggregators may not moderate or verify the reviews that are posted on their websites. In addition, some reviews may be provided by anonymous reviewers. As a result, such review aggregators may be susceptible to posting false or misleading reviews. For example, an entity may submit positive reviews of itself (or may offer incentives to others to do the same) to artificially inflate their own published reputation. In other examples, an entity may submit negative reviews of a competing entity in order to artificially deflate the competing entity's published reputation relative to their own. For these reasons, reputation information published by review aggregators may only be of limited value. Reputation information provided by other sources, such as social media websites, that allow users to provide reviews in an anonymous fashion and that do not moderate or verify reviews also may suffer from similar problems. Thus, businesses and merchants may not be able to confidently rely on such reputation information when assessing the risk of conducting business with an entity.

To provide reputation information having a high degree of accuracy and reliability, a reputation score can be generated based in part on verified financial information. The financial information can relate to financial transactions between the entity whose reputation is being assessed and a plurality of other entities, who may be individuals, merchants, or other organizations. Such information may be more reliable than other types of self-reported reputation information, such as unmoderated and/or unverified reviews which may be influenced in a variety of ways by the entity itself to improve its perceived reputation. Verified financial information may be analyzed to provide a more objective reputation score for the entity. In some arrangements, the verified financial information is combined with other external reputation information to provide a more comprehensive reputation score for the entity. The reputation score also may include a confidence metric component, which can indicate a level of confidence that the reputation score accurately reflects the reputation of the entity among potential customers, clients, and other transaction counterparties. Thus, businesses and individuals may use such a reputation score of an entity to accurately and confidently assess a risk level of conducting business with the entity. This disclosure addresses the technical problems associated with aggregating reputation information from a variety of sources, including sources relating to verified financial transactions, and providing a reputation score based on the aggregated reputation information.

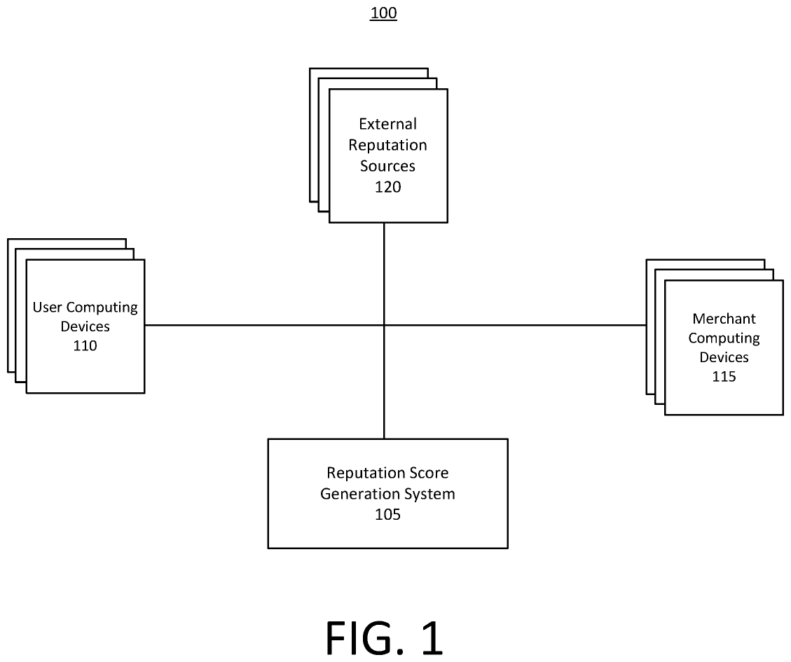

FIG. 1 is a block diagram of a computing environment 100 for providing a reputation score for an entity, according to an illustrative implementation. The environment 100 includes a reputation score generation system 105, a plurality of user computing devices 110, a plurality of merchant computing devices 115, and a plurality of external reputation sources 120. The computing environment of FIG. 1 can be used to provide a reputation score for an entity. In some arrangements, the entity is one a user of the one of the user computing devices 110. In other arrangements, the entity is a merchant associated with one of the merchant computing devices 115.

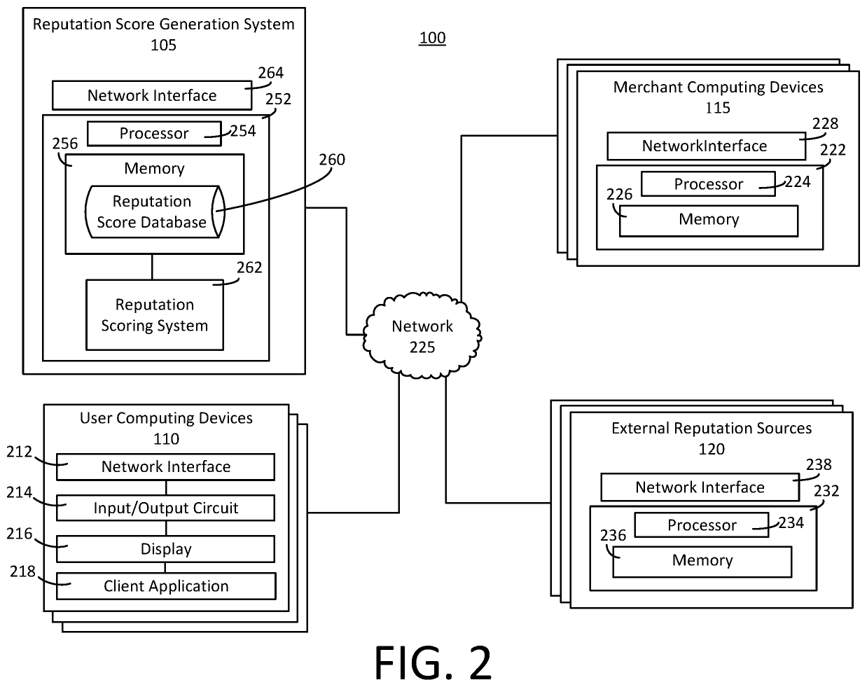

Referring now to FIG. 2, a detailed schematic diagram of the computing environment 100 of FIG. 1 is shown. The components of the environment 100 are communicatively coupled to one another via a network 225. In some arrangements, the network 225 includes any of the Internet, a private network, a wide area network (WAN), or a combination thereof. It should be understood that, although only a single network 225 is shown in FIG. 2 for illustrative purposes, in some arrangements the components of the environment 100 are interconnected to one another via two or more interconnected computer networks similar to the network 225.

The reputation score generation system 105 can be configured to provide a reputation score for an entity (e.g., a service provider, a merchant, a restaurant, etc.). The reputation score may include any information about the reputation of the entity as it relates to business or financial transactions that the entity has conducted in the past. Accordingly, the reputation score can be used (e.g., by consumers, merchants, etc.) to assess a risk level of conducting business with the entity in the future. In some arrangements, the reputation score generation system 105 generates a reputation score for an entity based on information it receives from any of the user computing devices 110, the merchant computing devices 115, and the external reputation sources 120.

In some arrangements, the user computing devices 110 are computing devices associated with individual users or small groups of users (e.g., a family), where each user is an individual. Each of the user computing devices 110 may be any type or form of computing device owned by, operated by, accessed by, or otherwise associated with a respective user. For example, each of the user computing devices 110 may be a server, a desktop computer, or a laptop computer. In some arrangements, each of the user computing devices 110 is a mobile computing device such as a tablet computing device, or a handheld computing device, such as a smartphone. In still other implementations, at least one of the user computing devices 110 may be an automated teller machine (ATM) or other currency dispensing device, or a point-of-sale computing device. In such arrangements, the point-of-sale computing device may include a card reader/writer configured to process financial transactions via the use of a credit card, a debit card, a stored value card, a chip reader/writer configured to process financial transactions via the use of a near-field communication (NFC)-enabled device.

Each user computing device 110 includes a network interface 212, an input/output circuit 214, a display 216, and a client application 218. The network interface 212 of the user computing device 110 is adapted for and configured to establish a communication session via the network 225 with the reputation score generation system 105 or the merchant computing devices 115. Accordingly, the network interface 212 includes any of a cellular transceiver (Code Division Multiple Access (CDMA), Global System for Mobile Communications (GSM), Long-Term Evolution (LTE), etc.), a wireless network transceiver (e.g., 802.11X, ZigBee, Bluetooth, etc.), or a combination thereof (e.g., both a cellular transceiver and a Bluetooth transceiver).

The display 216 is used to present account information, transaction information, and the like. In this regard, the display 216 is communicably and operatively coupled to the input/output circuit 214 to provide a user interface for receiving and displaying information on the user computing device 110. The input/output circuit 214 is structured to receive and provide communication(s) to a user of the user computing device 110. In this regard, the input/output circuit 214 is structured to exchange data, communications, instructions, etc., with an input/output component of the user computing device 110. Accordingly, in one embodiment, the input/output circuit 214 includes an input/output device such as a display device, a touchscreen, a keyboard, and a microphone. In another embodiment, the input/output circuit 214 may include communication circuitry for facilitating the exchange of data, values, messages, and the like between an input/output device and the components of the user computing device 110. In yet another embodiment, the input/output circuit 214 may include machine-readable media for facilitating the exchange of information between the input/output device and the components of the user computing device 110. In still another embodiment, the input/output circuit 214 may include any combination of hardware components (e.g., a touchscreen), communication circuitry, and machine-readable media.

The client application 218 is communicably coupled to the reputation score generation system 105 and the merchant computing devices 115 via the network 125, and may be structured to permit completion of financial transactions via the client application 218. In this regard, the client application 218 may provide displays indicative of current account balances, pending transactions, profile information (e.g., contact information), and the like. Further, in some embodiments, the client application 218 may also permit payments to and/or from the user to a designated recipient (e.g., a merchant associated with a merchant computing device 115). For example, the client application 218 may depict a loan of a customer (e.g., mortgage) and allow the user to pay the mortgage from one of their accounts (e.g., checking or savings). In another example, a bill pay option may be provided by the client application 218, where the bill pay option allows the user to pay his/her bills.

The merchant computing devices 115 may each correspond to a computing device owned by, operated by, accessed by, or otherwise associated with a respective merchant. Generally, a merchant may be a business or other organization that offers goods and/or services for sale to other merchants or to individuals (e.g., users of the user computing devices 110). Like the user computing devices 110, each merchant computing device 115 also may be implemented as any type and form of computing device, including a server, a desktop computer, a laptop computer, a tablet computing device, a smartphone, an ATM, or a point-of-sale computing device.

As shown, each merchant computing device 115 includes a processing circuit 222 having a processor 224 and a memory 226. The processor 224 may be implemented as a general-purpose processor, an application specific integrated circuit (ASIC), one or more field programmable gate arrays (FPGAs), a digital signal processor (DSP), a group of processing components, or other suitable electronic processing components. The one or more memory devices 226 (e.g., RAM, NVRAM, ROM, Flash Memory, hard disk storage, etc.) may store data and/or computer code for facilitating the various processes described herein. Moreover, the one or more memory devices 226 may be or include tangible, non-transient volatile memory or non-volatile memory. Accordingly, the one or more memory devices 226 may include database components, object code components, script components, or any other type of information structure for supporting the various activities and information structures described herein.

The merchant computing device 115 further includes a network interface 228. The network interface 228 is adapted for and configured to establish a communication session via the network 225 with the reputation score generation system 105 and the user computing devices 110. Accordingly, the network interface 228 includes any of a cellular transceiver (CDMA, GSM, LTE, etc.), a wireless network transceiver (e.g., 802.11X, ZigBee, Bluetooth, etc.), or a combination thereof (e.g., both a cellular transceiver and a Bluetooth transceiver).

The external reputation sources 120 each may correspond to an electronic source of reputational information for various entities. For example, an external reputation source may be a website that provides a rating or score based on aggregated reviews submitted by various users (e.g., Yelp®, TripAdvisor®, Angie's List®, etc.). In some arrangements, an external reputation source 120 includes a social media website on which a user has provided information that may be relevant to the reputation of an entity. In still other implementations, an external reputation source 120 includes a computing device that maintains criminal records or tax information relating to an entity. It should be understood that the external reputation sources 120 may include various types of computing devices, such as any of the types of computing devices discussed above in connection with the user computing devices 110 and the merchant computing devices 115.

As shown, each external reputation source 120 includes a processing circuit 232 having a processor 234 and a memory 236. The processor 234 may be implemented as a general-purpose processor, an ASIC, one or more FPGAs, a DSP, a group of processing components, or other suitable electronic processing components. The one or more memory devices 236 (e.g., RAM, NVRAM, ROM, Flash Memory, hard disk storage, etc.) may store data and/or computer code for facilitating the various processes described herein. Moreover, the one or more memory devices 236 may be or include tangible, non-transient volatile memory or non-volatile memory. Accordingly, the one or more memory devices 236 may include database components, object code components, script components, or any other type of information structure for supporting the various activities and information structures described herein.

The external reputation source 120 further includes a network interface 238. The network interface 238 is adapted for and configured to establish a communication session via the network 225 with the reputation score generation system 105. Accordingly, the network interface 238 includes any of a cellular transceiver (CDMA, GSM, LTE, etc.), a wireless network transceiver (e.g., 802.11X, ZigBee, Bluetooth, etc.), or a combination thereof (e.g., both a cellular transceiver and a Bluetooth transceiver).

The reputation score generation system 105 facilitates calculation of a reputation score for an entity (e.g., a user of a user computing device 110 or a merchant associated with a merchant computing device 115). As shown, reputation score generation system 105 includes a processing circuit 252 having a processor 254 and a memory 256. The processor 254 may be implemented as a general-purpose processor, an ASIC, one or more FPGAs, a DSP, a group of processing components, or other suitable electronic processing components. The one or more memory devices 256 (e.g., RAM, NVRAM, ROM, Flash Memory, hard disk storage, etc.) may store data and/or computer code for facilitating the various processes described herein. Moreover, the one or more memory devices 256 may be or include tangible, non-transient volatile memory or non-volatile memory. Accordingly, the one or more memory devices 256 may include database components, object code components, script components, or any other type of information structure for supporting the various activities and information structures described herein.

The reputation score generation system 105 further includes a network interface 264, which is used to establish connections with other components of the environment 100 by way of the network 225. The network interface 264 includes program logic that facilitates connection of the reputation score generation system 105 to the network 225. The network interface 264 supports communication between the reputation score generation system 105 and other systems, such as the user computing devices 110, the merchant computing devices 115, and the external reputation sources 120. For example, the network interface 264 includes a cellular modem, a Bluetooth transceiver, a Bluetooth beacon, a radio-frequency identification (RFID) transceiver, and an NFC transmitter. In some arrangements, the network interface 264 includes the hardware and machine-readable media sufficient to support communication over multiple channels of data communication. Further, in some arrangements, the network interface 264 includes cryptography capabilities to establish a secure or relatively secure communication session with user computing devices 110, the merchant computing devices 115, and the external reputation sources 120. In this regard, financial data (or other types of data) may be encrypted and transmitted to prevent or substantially prevent the threat of hacking.

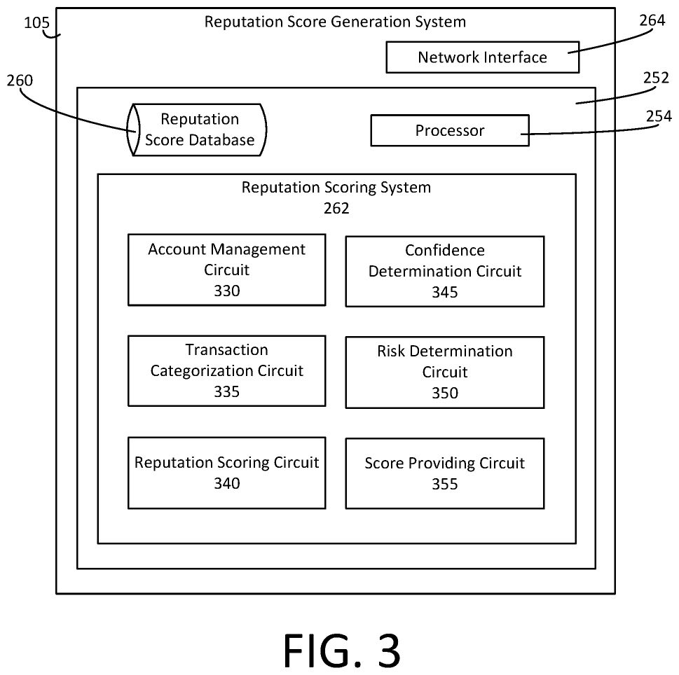

The reputation score generation system 105 further includes a reputation score database 260. The reputation score database 260 is configured to hold, store, categorize, and otherwise serve as a repository for information associated with a reputation score of an entity. For example, the reputation score database 260 may store information relevant to the reputation score of an entity, such as account numbers, account balances, transaction history, and reputation score history. The reputation score database 260 is structured to selectively provide access to information relating to a reputation score of an entity. In this regard, as discussed further herein, the reputation score database 260 is communicably and operatively coupled to the reputation scoring system 262 to provide access to such information. The reputation scoring system 262 is configured to generate and manage one or more reputation scores for one or more entities. The reputation scoring system 262 is described further below in connection with FIG. 3.

The reputation score generation system 105 may be maintained by an organization, such as a financial institution, that also has access to financial accounts associated with at least some of the users of the user computing devices 110 and/or at least some of the merchants associated with the merchant computing devices 115. For example, the reputation score generation system 105 may be maintained by a bank that maintains the accounts of users and/or processes transactions between customers and the merchants associated with the merchant computing devices 115. In one example, a user computing device 110 includes a desktop computer, and a merchant computing device 115 includes a server. In this example, a user accesses a shopping website hosted by the merchant computing device 115 via the user computing device 110, and makes an online purchase from the merchant. Communications between the user computing device 110 and the merchant computing device 115 may traverse the network 225. In some arrangements, at least some such communications also are received by the reputation score generation system 105 (e.g., via the network interface 264). In some other implementations, the reputation score generation system 105 may receive an indication that a financial transaction has taken place between a user and a merchant, for example if the user paid for the purchase with funds stored in an account to which the reputation score generation system 105 has access. The reputation score generation system 105 can use such financial transaction information, along with information received from the external reputation sources 120, to generate a reputation score for an entity, as discussed further below.

Referring now to FIG. 3, a detailed schematic diagram of the reputation scoring system 262 and part of the reputation score generation system 105 included in the environment 100 of FIG. 2 is shown, according to an illustrative implementation. The reputation scoring system 262 is shown to include an account management circuit 330, a transaction categorization circuit 335, a reputation scoring circuit 340, a confidence determination circuit 345, a risk determination circuit 350, and a score providing circuit 355. It should be understood that other arrangements may include more or fewer circuits without departing from the spirit and scope of this disclosure. Furthermore, in some arrangements, the functionality of one or more circuits may be combined into a single circuit. The reputation scoring system 262 is operably and communicatively coupled to the reputation score database 260 and the processor 254. FIG. 3 is described with reference to FIGS. 1 and 2 below.

The account management circuit 330 can be configured to manage a plurality of accounts each associated with a respective account holder. In some arrangements, the accounts are financial accounts maintained by the organization (e.g., a financial institution) that maintains the reputation score generation system 105. The accounts may include savings accounts, checking accounts, credit card accounts, or any other type or form of financial account. Information relating to the accounts can be stored, for example, in the reputation score database 260. The account holders of the accounts can include users associated with the user computing devices 110 or merchants associated with the merchant computing devices 115 shown in FIGS. 1 and 2.

In some arrangements, the account management circuit 330 is configured to process transactions associated with the accounts. For example, a user of a user computing device 110 may be the holder of a credit card account whose information is stored in the reputation score database 260. When the user attempts to purchase an item from a merchant, the account management circuit 330 can receive a notification of the requested transaction via the network 125. The account management circuit 330 can be configured to retrieve corresponding account information from the reputation score database 260. In some arrangements, the account management circuit 330 determines whether the account has sufficient credit or funds available to complete the requested transaction. If so, the account management circuit 330 can be configured to authorize the financial transaction, deduct the appropriate amount of credit or funds from the account, and transfer the corresponding funds to an account associated with the merchant (or initiate a transfer of funds to another financial institution holding the account associated with the merchant). The account management circuit 330 can also be configured to store a record of the financial transaction in the reputation score database 260. In another example, a merchant associated with a merchant computing device 115 is the holder of a business checking account whose information is stored in the reputation score database 260. When a purchaser buys an item from the merchant (e.g., by swiping a credit card on a card reading device corresponding to the merchant computing device 115), the account management circuit 330 can be configured to receive the corresponding funds for the transaction and to update the account information stored in the reputation score database 260 to include an indication that the transaction has been completed.

It should be understood that the examples provided above are illustrative only, and that many other types of transactions may be processed by the account management circuit 330 without departing from the scope of this disclosure. For example, in some arrangements, the account management circuit 330 is configured to process transactions corresponding to merchandise returns. When a user returns previously purchased goods to a merchant, the account management circuit 330 can receive a notification that the return has occurred, and may credit the user's account with funds equal to the purchase price of the returned merchandise. The account management circuit 330 also can deduct the amount of the purchase price from an account of the merchant in response to a returned merchandise transaction. In another example, the account management circuit 330 is configured to process transactions corresponding to credit card disputes. It should also be understood that, in some arrangements, the account management circuit 330 may not have access to an account associated with one of the parties to a transaction. However, the account management circuit 330 can be capable of processing a financial transaction provided that at least one of the parties to the transaction is the holder of an account to which the account management circuit 330 has access.

The transaction categorization circuit 335 can be configured to determine a transaction type associated with each financial transaction processed by the account management circuit 330. In some arrangements, the transaction categorization circuit 335 is configured to determine a category for a transaction in an automated fashion based on information relating to the transaction. For example, the transaction categorization circuit 335 can retrieve information corresponding to a transaction from the reputation score database 260. In some arrangements, the information retrieved includes an account number associated with the transaction, identification information for a holder of the account, a dollar amount of the transaction, and identification information for a counterparty to the transaction. In some arrangements, the account information includes a description of the transaction, which may be provided, for example, as human-readable text-based information. Based on the transaction information retrieved from the reputation score database 260, the transaction categorization circuit 335 can associated the transaction with a transaction type. For example, if the transaction categorization circuit 335 determines that the transaction occurred within an account held by an individual and that the transaction involved shifting funds from the account held by the individual to the counterparty of the transaction, the transaction categorization circuit 335 can categorize the transaction as a purchase.

In another example, if the transaction categorization circuit 335 determines that the transaction occurred within the same account held by the individual and that the transaction involved shifting funds into the account held by the individual, the transaction categorization circuit 335 may categorize the transaction as a return or a refund. Other transaction types are also possible. For example, the transaction categorization circuit 335 also may determine that a transaction corresponds to a disputed credit card transaction, or a declined credit card transaction. After the type of transaction has been determined, the transaction categorization circuit 335 can store the transaction type in the reputation score database 260.

The reputation scoring circuit 340 can be configured to determine a reputation score for an entity. In some arrangements, the reputation score is based at least in part on the types of transactions that the entity has been associated with, as well as other reputation information that may be received from the external reputation sources 120. For example, to generate a reputation score for a particular entity, the reputation scoring circuit 340 can retrieve from the reputation score database 260 information relating to all of the financial transactions in which the entity was involved. For a merchant entity, these may include financial transactions associated with a variety of other counterparties, including users of the user computing devices 110 as well as other merchants associated with the merchant computing devices 115. In some arrangements, there may be a large number of transactions involving the entity. For example, the reputation score database 260 may store information relating to hundreds, thousands, or millions of transactions involving the entity.

In some arrangements, the reputation scoring circuit 340 is configured to adjust the reputation score for the entity based at least in part on the types of transactions associated with the entity. For example, a merchant entity's reputation score may be adjusted upwards for positive transactions such as sales, but may be adjusted downwards for negative transactions, such as returns or refunds, which may indicate that purchasers were dissatisfied with their purchases. In some arrangements, the reputation scoring circuit 340 is configured to adjust the reputation score for a merchant entity upwards in response to a repeated transactions by the same user or set of users, as this may indicate that the user or set of users are maintaining an ongoing business relationship with the merchant entity. In some arrangements, the reputation scoring circuit 340 uses the relative percentages of different transaction types for an entity in determining the reputation score for the entity. For example, the reputation scoring circuit 340 can determine that an entity having a relatively high percentage of sales-related transactions and a relatively low percentage of transactions corresponding to credit card disputes may be assigned a relatively high score by the reputation scoring circuit 340. In contrast, the reputation scoring circuit 340 may determine a relatively low reputation score for an entity having a relatively low percentage of sales-related transactions and a relatively high percentage of transactions corresponding to credit card disputes or merchandise returns.

In some arrangements, the reputation scoring circuit 340 is configured to receive external reputation information for an entity to be used in determining the overall reputation score for the entity. The reputation scoring circuit 340 can receive such information directly from the external reputation sources 120, or may instead retrieve such information from the reputation score database 260. As described above, external reputation information may be susceptible to manipulation making it less reliable than verified financial information such as information relating to financial transactions. However, external reputation information still may have value. Thus, the reputation scoring circuit 340 can be configured to enhance the reputation score for an entity based at least in part on a combination of verified financial information and external reputation information. In some arrangements, the reputation scoring circuit 340 determines a relatively higher reputation score for an entity associated with positive external reputation information, and may determine a relatively lower reputation score for an entity associated with negative external reputation information.

In some arrangements, the reputation scoring circuit 340 is configured to determine the reputation score for an entity based at least in part on a total number of transactions the entity has been involved in. For example, a relatively high number of transactions may indicate that the entity has achieved a high level of commercial success and, as a result, the reputation scoring circuit 340 may determine a relatively higher reputation score for such an entity. Similarly, the reputation scoring circuit 140 can be configured to determine an identity of the counterparty to each transaction involving the entity, and may then determine a total number or a percentage of repeat customers for the entity. Because repeat customers may be more likely to be satisfied with their dealings with the entity, the reputation scoring circuit 340 can be configured to assign a relatively high reputation score to an entity having a relatively high number or percentage of repeat customers.

In some arrangements, the reputation scoring circuit 340 determines a reputation score formatted in a variety of ways. In some arrangements, the reputation score is a numerical score. For example, the reputation score may be an integer between 1 and 10, or between 1 and 100, with higher numbers indicating a more positive reputation and lower numbers indicating a more negative reputation. In some arrangements, the reputation score is formatted as a letter. For example, the reputation score may be a letter from “A” through “F” similar to an academic grading scale, with a score of “A” indicating a highly positive reputation and a score of “F” indicating a very poor reputation. The reputation scoring circuit 140 also can be configured to select other formats for the reputation score.

The confidence determination circuit 345 can be configured to determine a confidence metric associated with a reputation score generated by the reputation scoring circuit 340. In some arrangements, the confidence metric indicates a level of confidence that the generated reputation score accurately reflects the reputation of the entity among potential customers, clients, and other transaction counterparties. In some arrangements, a reputation score generated based on a large dataset is more reliable than a reputation score generated based on a smaller dataset. Thus, in some arrangements the confidence determination circuit 345 is configured to determine a total number of financial transactions on which a generated reputation score is based, for example by retrieving that information from the reputation score database 260. If the total number of transactions is relatively high, the confidence determination circuit 345 can be configured to determine a higher confidence metric for the reputation score. If the total number of transactions is relatively low, the confidence determination circuit 345 can be configured to determine a lower confidence metric for the reputation score.

In some arrangements, the confidence determination circuit 345 determines a confidence metric based at least in part on the variety of data sources used for generating the reputation score. For example, if external reputation information from a large number of external reputation sources 120 was used by the reputation scoring circuit 340 to generate the reputation score, the confidence determination circuit 345 can be configured to determine a relatively high confidence metric for the reputation score. In some arrangements, the confidence determination circuit 345 is configured to determine a confidence metric based at least in part on a degree of consistency in the data received from a variety of sources. For example, if a large number of external reputation sources 120 indicate that a given entity has a positive reputation, and the financial transactions for the entity also indicate that the entity has a positive reputation, the confidence determination circuit 345 can be configured to generate a relatively high confidence metric for the reputation score of the entity. The confidence metric can be formatted in a variety of ways, for example as text or numerical information. In some arrangements, the confidence determination circuit 345 is configured to determine a confidence metric formatted in a manner similar to that of its associated reputation score.

The risk determination circuit 350 can be configured to determine a credit risk associated with the entity. In some arrangements, the credit risk is based at least in part on the reputation score of the entity as determined by the reputation scoring circuit 340. For example, the risk determination circuit 350 can be configured to determine a higher risk level for an entity having a relatively low reputation score, and can be configured to determine a lower risk level for an entity having a relatively high reputation score. In some arrangements, the risk determination circuit 350 is configured to weight certain information more heavily in determining the credit risk of an entity. For example, for an entity having a history of disputed credit card transactions, the risk determination circuit 350 can be configured to determine a relatively low credit risk even if other information (e.g., external reputation information) for the entity is generally positive.

The score providing circuit 355 can be configured to provide a visual representation of the reputation score of an entity, in response to a request for the reputation score. The score providing circuit 355 can receive a request for a reputation score, for example from one of the user computing devices 110 or from one of the merchant computing devices 115. The request may include an identification of the entity for whom the requester would like to view the reputation score. As described above, the reputation scoring circuit 340 can be configured to store the reputation scores for various entities in the reputation score database 260. The score providing circuit 355 can determine the identity of the entity associated with a request, retrieve the corresponding reputation score from the reputation score database 260, and provide information corresponding to the reputation score to the requester. For example, in some arrangements the score providing circuit 355 is configured to transmit information to the computing device that requested the reputation score (e.g., a user computing device 110 or a merchant computing device 115) that causes the computing device to display the reputation score on an electronic display screen associated with the computing device. In some arrangements, the score providing circuit 355 transmits information that causes the requesting computing device to display the reputation score within a web browsing application executing on the computing device.

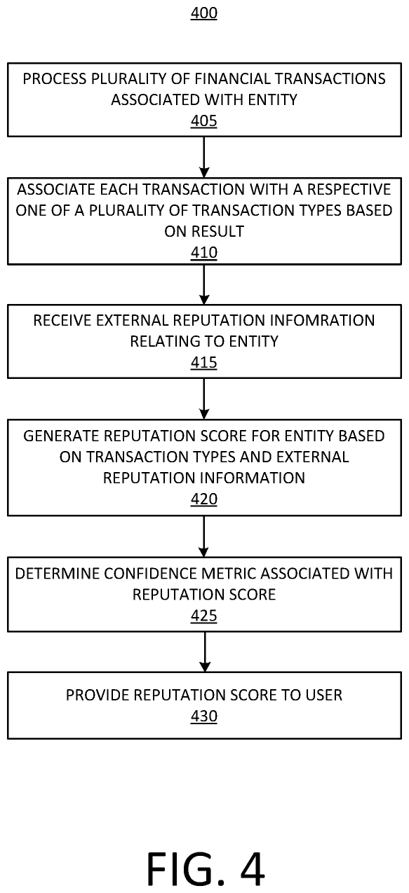

FIG. 4 is a flowchart illustrating an example method 400 for providing a reputation score for an entity, according to an illustrative implementation. The method 400 is performed by the reputation score generation system 105. Accordingly, in arrangements where the reputation score generation system 105 is part of a financial institution, the method 400 may be performed by a financial institution computing system that includes the reputation score generation system 105. Generally, through the method 400, the reputation score generation system 105 generates a reputation score for a given entity based at least in part on known financial transactions involving the entity and on external reputation information.

The method 400 begins when a plurality of financial transactions associated with an entity are processed at 405. In some arrangements, this is performed by an account management circuit such as the account management circuit 330 shown in FIG. 3. For example, a user of a user computing device may attempt to purchase an item from a merchant, and the account management circuit can receive a notification of the requested transaction. The account management circuit can be configured to process the transaction, such as by authorizing the transaction and transferring the corresponding funds from an account held by the user, or by denying the transaction. In some arrangements, the account management circuit stores a record of the financial transaction in a memory or other data storage device. The account management circuit can process any number of other transactions involving the entity (e.g., the merchant) in a similar manner.

Each of the plurality of transactions are associated with a respective one of a plurality of transaction types based on a result associated with each of the plurality of transactions at 410. In some arrangements, this is performed by a transaction categorization circuit such as the transaction categorization circuit 335 shown in FIG. 3. In some arrangements, the transaction categorization circuit is configured to determine a category for a transaction based on information relating to the transaction. For example, the transaction categorization circuit can determine that the transaction occurred within an account held by an individual and that the transaction involved shifting funds from the account held by the individual to the counterparty of the transaction, and may therefore further determine that the transaction was a purchase. Similarly, the transaction categorization circuit can determine that a transaction involved shifting funds into the account held by an individual, and may therefore further determine that the transaction was a return or a refund. In some arrangements, the transaction categorization circuit also determines that a transaction corresponds to a disputed credit card transaction, or a declined credit card transaction.

In some arrangements, external reputation information relating to the entity is received at 415. In some arrangements, this is performed by a reputation scoring circuit such as the reputation scoring circuit 340 shown in FIG. 3. In some arrangements, the reputation scoring circuit receives such information directly from the external reputation sources, which may include website that aggregate reviews of entities, social media websites, or other sources of information such as tax information, criminal records, or customer feedback for the entity. It should be noted that, in some other arrangements, external reputation information may not be received, and therefore the reputation score may be generated based only on other information.

The reputation score for the entity is generated at 420, based at least in part on the transaction types of the plurality of financial transactions and the external reputation information. In some arrangements, the reputation score is generated by the reputation scoring circuit. To generate a reputation score for a particular entity, the reputation scoring circuit can retrieve information relating to all of the financial transactions in which the entity was involved. In some arrangements, a merchant entity's reputation score is increased as a result of positive transactions such as sales to consumers, but is decreased as a result of negative transactions, such as returns or refunds issued to consumers. In some arrangements, the relative percentages of different transaction types for the entity are used to determine the reputation score for the entity.

In some arrangements, the reputation scoring circuit adjusts the reputation score for a merchant entity upwards in response to a repeated transactions by the same user or set of users. For example, such repeated transactions may indicate that these users believe the merchant entity to be reliable and are therefore willing to continue doing business with the merchant entity based on their positive past transactions. Similar criteria can be used to generate a reputation score for an entity corresponding to an individual. For example, the individual's past transactions may indicate a level of trustworthiness. In some arrangements, the reputation score for an individual is increased as a result of successfully completed transactions, but is decreased as a result of unsuccessful transactions, which can indicate that the user attempted to purchase goods or services but did not have the necessary funds to complete the purchases.

In some arrangements, external reputation information for the entity is used in determining the overall reputation score for the entity. The reputation scoring circuit can receive such information directly from external reputation sources such as the external reputation sources 120 shown in FIGS. 1 and 2, or may instead retrieve such information from a database. To account for potential unreliability of external reputation information, the reputation scoring circuit enhances the reputation score for an entity based at least in part on a combination of verified financial information and external reputation information. In some arrangements, the reputation scoring circuit determines a relatively higher reputation score for an entity associated with positive external reputation information, and may determine a relatively lower reputation score for an entity associated with negative external reputation information.

In some arrangements, the reputation score for the entity is determined based at least in part on a total number of transactions the entity has been involved in. For example, a relatively low number of total transactions may indicate that the entity is relatively inexperienced and, as a result, a relatively lower reputation score may be generated for such an entity even if the few transactions conducted by the entity have been positive. In some arrangements, the reputation score for the entity is determined based at least in part on the identities (and associated reputation scores) of counterparties that have conducted transactions with the entity. For example, an entity who regularly conducts business with another entity having a high reputation score can also be determined to have a high reputation score itself.

The reputation score can formatted in a variety of ways. In some arrangements, the reputation score is a numerical score. For example, the reputation score may be an integer between 1 and 10, or between 1 and 100, with higher numbers indicating a more positive reputation and lower numbers indicating a more negative reputation. In some arrangements, the reputation score is formatted as a letter. For example, the reputation score may be a letter from “A” through “F” similar to an academic grading scale, with a score of “A” indicating a highly positive reputation and a score of “F” indicating a very poor reputation.

In some arrangements, a confidence metric associated with the reputation score can be generated at 425. This can be performed, for example, by the confidence determination circuit 345 shown in FIG. 3. The confidence metric is any metric indicating a level of confidence that the generated reputation score accurately reflects the reputation of the entity among potential customers, clients, and other transaction counterparties. In some arrangements, the a total number of financial transactions on which a generated reputation score is based can be determined. If the total number of transactions is relatively high, a higher confidence metric can be determined for the reputation score because the score is based on a relatively large dataset of transactions. In contrast, if the total number of transactions is relatively low, a lower confidence metric can be determined for the reputation score.

The reputation score can be provided to a user at step 430. This can be performed by the score providing circuit 355 shown in FIG. 3. In some arrangements, the reputation score can be provided in response to a request for such information. A request for the reputation score can be received, for example, from one of the user computing devices 110 or from one of the merchant computing devices 115 shown in FIGS. 1 and 2, and includes an identification of the entity for whom the reputation score is requested. The corresponding reputation score can be located in a memory device, such as the reputation score database 260 shown in FIG. 3. After the reputation score has been received, information corresponding to the reputation score is transmitted to an electronic device, such as the user computing devices 110. The reputation score can be displayed, for example, by the display 216 of the user computing device 110 shown in FIG. 2.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more dedicated processors communicatively coupled to one or more dedicated memory or memory devices. In this regard, the one or more dedicated processors may execute instructions stored in the dedicated memory or may execute instructions otherwise accessible to the one or more dedicated processors. In some embodiments, the one or more dedicated processors may be embodied in various ways. The one or more dedicated processors may be constructed in a manner sufficient to perform at least the operations described herein. In some embodiments, the one or more dedicated processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more dedicated processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more dedicated processors may take the form of a single core processor, multi-core processor (e.g., a dual core processor, triple core processor, quad core processor, etc.), microprocessor, etc.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A computer-implemented method for providing a reputation score, the method comprising:
generating, by a reputation score generation system communicatively coupled to a bill pay client application associated with a user, a reputation score for the user, the reputation score for the user based at least on a history of verified financial transactions between the user and a plurality of business entities and on external reputation information associated with the user;
causing the bill pay client application deployed to a user computing device and associated with a financial account held by the user, to transmit a financial transaction request, the financial transaction request being a payment from the financial account held by the user to a particular business entity; wherein;
receiving, by the reputation score generation system, the financial transaction request;
determining, by the reputation score generation system, that the financial transaction was not completed due to insufficient funds in the financial account held by the user;
based on the determination, decreasing, by the reputation score generation system, the reputation score; and
determining, by a confidence determination circuit of the reputation score generation system, a confidence metric associated with the reputation score, the confidence metric based on a number of financial transactions associated with the user, wherein information regarding the number of financial transactions is stored in non-transitory memory associated with the reputation score generation system.

2. The computer-implemented method of claim 1, wherein the financial transactions stored in the non-transitory memory comprise at least one of a sale transaction type and a return transaction type.

3. The computer-implemented method of claim 2, wherein generating the reputation score comprises generating, by the reputation scoring circuit, the reputation score based on a relative percentage of each transaction type for the financial transactions stored in the non-transitory memory.

4. The computer-implemented method of claim 1, further comprising:
determining, by the reputation scoring circuit, a total number of financial transactions stored in the non-transitory memory, wherein generating the reputation score further comprises generating, by the reputation scoring circuit, the reputation score based on the total number of financial transactions.

5. (canceled)

6. The computer-implemented method of claim 1, further comprising determining, by a risk determination circuit, a credit risk, based at least in part on the reputation score.

7. The computer-implemented method of claim 1, wherein the external reputation information comprises information corresponding to at least one of social media activity, a criminal record, and tax information.

8. (canceled)

9. (canceled)

10. The computer-implemented method of claim 1, wherein the user is an individual.

11. The computer-implemented method of claim 1, further comprising:
storing, by the reputation scoring circuit, the reputation score in a data storage device;
receiving, by a score providing circuit, a request for the reputation score; and
transmitting, by the score providing circuit, information corresponding to the reputation score to cause the reputation score to be displayed on an electronic display screen.

12. A system for providing a reputation score, the system comprising:
a reputation score generation system communicatively coupled to a bill pay client application deployed to a user computing device associated with a user, the reputation score generation system configured to:
generate a reputation score for the user, the reputation score for the user based at least on a history of verified financial transactions between the user and a plurality of business entities and on external reputation information associated with the user;
receive, from the bill pay client application, a financial transaction request, the financial transaction request being a payment from the financial account held by the user to a particular business entity;
determine that the financial transaction was not completed due to insufficient funds in the financial account held by the user;
based on the determination, decrease the reputation score; and
generate a confidence metric associated with the reputation score, the confidence metric based on a number of financial transactions associated with the user, wherein information regarding the number of financial transactions is stored in non-transitory memory associated with the reputation score generation system.

13. The system of claim 12, wherein the financial transactions stored in the non-transitory memory comprise at least one of a sale transaction type and a return transaction type.

14. The system of claim 13, wherein a reputation scoring circuit of the reputation score generation system is further configured to generate the reputation score based on a relative percentage of each transaction type for the financial transactions stored in the non-transitory memory.

15. The system of claim 12, wherein the reputation scoring circuit of the reputation score generation system is further configured to:
determine a total number of financial transactions stored in the non-transitory memory; and
generate the reputation score based on the total number of financial transactions.

16. (canceled)

17. The system of claim 12, further comprising a risk determination circuit configured to determine a credit risk, based at least in part on the reputation score.

18. The system of claim 12, wherein the external reputation information comprises information corresponding to at least one of social media activity, a criminal record, and tax information.

19. (canceled)

20. (canceled)

21. The system of claim 12, wherein the user is an individual.

22. The system of claim 12, further configured to store the reputation score in a data storage device, the system further comprising a score providing circuit configured to:
receive a request for the reputation score; and
transmit information corresponding to the reputation score to cause the reputation score to be displayed on an electronic display screen.

23. Non-transitory computer-readable media comprising computer-executable instructions stored thereon, the instructions, when executed by a processor of a computing system, causing the computing system to perform operations comprising:
generate a reputation score for a user, the reputation score for the user based at least on a history of verified financial transactions between the user and a plurality of business entities and on external reputation information associated with the user;
cause a bill pay client application to generate and transmit a financial transaction request, the financial transaction request being a payment from the financial account held by the user to a particular business entity;
determine that the financial transaction was not completed due to insufficient funds in the financial account held by the user;
based on the determination, decrease the reputation score; and
generate a confidence metric associated with the reputation score, the confidence metric based on a number of financial transactions associated with the user, wherein information regarding the number of financial transactions is stored in non-transitory memory associated with the processor.

24. The media of claim 23, wherein the financial transactions stored in the non-transitory memory comprise at least one of a sale transaction type and a return transaction type.

25. The media of claim 23, the operations further comprising:
determine a total number of financial transactions stored in the non-transitory memory; and
generate the reputation score based on the total number of financial transactions.

26. The media of claim 23, the operations further comprising determine a credit risk based at least in part on the reputation score.

27. The media of claim 23, wherein the external reputation information corresponds to at least one of social media activity, a criminal record, and tax information.

28. The media of claim 23, the operations further comprising:
receive a request for the reputation score; and
transmit information corresponding to the reputation score to cause the reputation score to be displayed on an electronic display screen.
